(19) United States
(12) Patent Application Publication
(10) Pub. No.: US 2026/0024031 A1
(43) Pub. Date: Jan. 22, 2026

(54) SYSTEMS AND METHODS FOR VERIFYING A DELEGATE

(71) Applicant: Wells Fargo Bank, N.A., San Francisco, CA (US)

(72) Inventors: Jennifer A. Fisher, Belmont, CA (US); Jenny Y. Tao, Philadelphia, PA (US); Young M. Yang, San Francisco, CA (US); Prafullata Diwate, San Francisco, CA (US)

(21) Appl. No.: 18/777,037

(22) Filed: Jul. 18, 2024

(51) Int. Cl. G06Q 10/0631

(52) U.S. Cl. CPC G06Q 10/06311

(57) ABSTRACT

Systems, apparatuses, methods, and computer program products are disclosed for verifying a delegate. An example method includes receiving an authority delegation request from a first user device associated with a first user and determining, based on a delegation parameter set, a delegated action. The example method further includes storing the delegated action in a user authority delegation profile associated with the first user and receiving an authority verification request from a second user device associated with a second user. The example method further includes determining an authority verification result and causing transmission of an indication of the authority verification result to the second user device.

### BACKGROUND

Delegations of authority are frequently performed across various industries. As a result, entities are often required to verify purported delegates. However, delegations of authority are often informal and thus not easily verifiable. Therefore, various shortcomings and technical challenges exist that make it difficult for an entity to efficiently and/or accurately verify a purported delegate.

### BRIEF SUMMARY

As individuals continue to live increasingly busy lives, assigning a delegated authority to perform particular tasks (e.g., actions) on an individual's behalf has provided great benefits, such as increasing an individual's productivity by reducing the individual's workload (e.g., via delegations). As such, performing delegations of authority are now ubiquitous in society, and therefore it is necessary for entities (e.g., businesses, organizations, universities, individuals, or the like) across all industries to interact with and verify purported delegates. However, interactions with purported delegates may expose the entity that is interacting with the purported delegate and the delegating party to unique risks, given that a bad actor may exploit an entrusted resource by posing as a legitimate delegate, which may lead to breaches in confidentiality, financial loss, legal repercussions, damage to an entity or a delegating party's reputation, and/or the like. In this regard, thoughtful verification techniques are required to ensure the authenticity of a purported delegate.

Traditionally, a delegation of authority may be memorialized through written documentation that is signed by the delegating party. The delegate may then present the written and signed documentation to an entity that can verify the delegation of authority. The entity that is presented the signed document may utilize any suitable document analysis technique to verify the purported delegation of authority, such as signature analysis techniques, document tamper detection techniques, and/or the like. For example, assume a purported delegate forged the signature of the delegating party on a written document that states that the bad actor (e.g., the purported delegate) is a delegate that is authorized to perform a particular task (e.g., picking up a child from school). As a result, the entity (e.g., the school) may be required to perform or request the performance of a document analysis technique (e.g., signature analysis, document tampering detection analysis, an/or the like) on the written document to determine whether the written document provided by the purported delegate is authentic.

While written documentation may be utilized to verify a purported delegation of authority and/or to memorialize a delegation of authority, solely relying on written documentation to perform such a memorialization and/or verification has many shortcomings and blind spots that limits its capabilities. In particular, generating and obtaining written documentation while delegating authority is time-consuming for the delegating party and delegate. Thus, delegations of authority are often performed informally (e.g., orally delegating authority) without any type of accompanying written documentation that memorializes the delegation. For example, assume an individual is busy at work and is unable to pick-up their child from school. As a result, the individual may orally delegate authority to a trusted coworker to pick-up their child. However, since the coworker was merely delegated authority orally, the school may be unable to verify the authenticity of the purported delegate (e.g., the coworker). Additionally, even if written documentation that states that the coworker is authorized for child pick-up is provided to the verifying entity by the coworker or the individual delegating authority, the written documentation may be subject to tampering techniques that require sophisticated analysis to discover, which the verifying entity (e.g., a school) may not be equipped to perform in real-time or at all. To this end, a blind spot exists that allows, for example, a bad actor to perform an unauthorized action by presenting, to a third-party verifier, a forged document that appears to authentically memorialize a delegation of authority for the bad actor to act on the delegating party's behalf (e.g., perform a child pick-up).

The inherent blind spots and limitations associated with verifying a purported delegate presents a technical problem insofar as non-technical solutions have not solved the inherent concerns listed above. As such, a need exists for a technical solution that (i) securely memorializes delegations of authority that are auditable to a third-party verifier (e.g., an entity, such as an individual, business, organization, university, government agency, or the like) and (ii) efficiently determines the authenticity of a purported delegate in real-time. Example embodiments provide a technical solution to this technical problem because example embodiments do not require manual intervention and operate in ways that deviate from traditional manual solutions for delegation of authority. Further, by leveraging a mobile driver's license (mDL) to verify the authenticity of a purported delegate, example embodiments provide a technical solution that streamlines the delegate verification process, enhances security, and thereby optimizes efficiency and bolsters trust for (1) a delegating party to safely delegate authority and (2) a third-party verifier to accurately verify a purported delegate.

Example embodiments described herein mitigate the above concerns by creating and using a centralized system that stores delegations of authority within a profile associated with the delegating party and leverages a mobile driver's license (mDL) and the stored delegations to efficiently and securely verify a purported delegate. To do so, example embodiments may receive an authentication request from a first user device associated with a first user. The authentication request may be an electronic request that comprises authentication information associated with the first user (e.g., a username and password, biometric data, a one-time password, a personal identification number (PIN), and/or the like). Example embodiments may then determine, based on the authentication information, an authentication result by comparing the received authentication information to stored baseline authentication information associated with the first user. In response to a successful authentication result, example embodiments may establish an authenticated session with the first user.

Example embodiments may then receive an authority delegation request from the first user device associated with the first user. The authority delegation request may be an electronic request that comprises a delegation parameter set. The delegation parameter set may indicate at least a task (e.g., school pick-up, authorizing a guardian to sign on a child's behalf, or the like) and a delegate (e.g., an individual, group of individuals, and/or the like). In addition, the delegation parameter set may include indications of one or more delegation constraints that are determined by the individual delegating authority (e.g., the delegating party), such as a particular date and/or time that the delegations of authority begins and/or expires, a total number of actions that may be performed by the delegate until the delegation of authority expires, a total number of actions performed by the delegate within a particular period of time until the delegation of authority expires (e.g., a maximum of occurrences per week where the delegate may perform the delegated action), and/or the like. For example, a delegated parameter set that is included in an authority delegation request may indicate that person A is authorized to perform a school pick-up operation for person A's children from January 2024 until May 2024.

Example embodiments may also determine a delegated action based on the delegation parameter set. A delegated action may describe at least a particular action, an individual that may perform the particular action, and any one or more delegation constraints. Example embodiments may store the determined delegated action in a user authority profile associated with the first user (e.g., the delegating party). A user authority profile may be associated with a particular user and may store any type of delegated actions (e.g., expired delegated actions, active delegated actions, or the like) that the particular user has previously delegated.

Example embodiments may also receive an authority verification request from a second user device associated with a second user (e.g., an individual that may be associated with an entity that wishes to verify a purported delegate). The authority verification request may be an electronic request that requests the verification of a third user (e.g., a purported delegate). For example, the authority verification request may include an indication of (i) a mobile driver's license (mDL) of the third user and (ii) the action (e.g., a school pick-up action) that the purported delegate requests to perform. Example embodiments may utilize the indication of the mDL included in the authority verification request to generate a digital token comprising cryptographic information associated with the mDL. The cryptographic information associated with the mDL may include cryptographical information associated with a user device to which the mDL corresponds, desired credential data associated with the mDL, location data, user profile data, user account data, social media data, or smart wallet identification data. Example embodiments may then transmit the digital token to an issuing authority (IA) system associated with an IA that provisioned the mDL. Subsequently, example embodiments may receive a mDL validity response from the IA system that indicates credential data associated with the mDL. Using at least the received credential data, example embodiments may determine an authority verification result.

Example embodiments may also cause transmission of an indication of the authority verification result to the second user device. The indication of the authority verification result may be an electronic message or notification that comprises a graphic and/or text, electronic instructions for the second user device to perform haptic response, or the like, such that the second user utilizes the received indication of the authority verification result to permit or deny the performance of an action requested by the purported delegate. For example, the authority verification result may include an electronic message including text that indicates that the particular user is authorized to perform the delegated task.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for verifying a delegate, in accordance with some example embodiments described herein.

FIG. 4 illustrates an example flowchart for establishing an authenticated session with a first user, in accordance with some example embodiments described herein.

FIG. 5 illustrates an example flowchart for using an indication of a mDL to receive an mDL validity response, in accordance with some example embodiments described herein.

FIG. 6 illustrates an example flowchart for using an authentication score to determine an authority verification result, in accordance with some example embodiments described herein.

FIG. 7 illustrates an example flowchart for using a supplemental verification request to determine an updated authority verification result, in accordance with some example embodiments described herein.

FIG. 8 illustrates a swim lane diagram with example operations that may be performed by components of the environment depicted in FIG. 1, in accordance with some example embodiments described herein.

FIG. 9 illustrates an example user interface associated with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

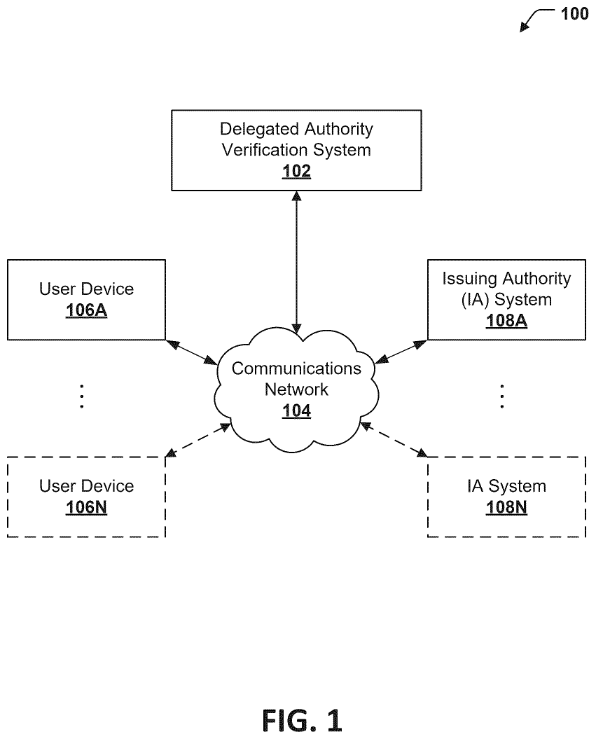

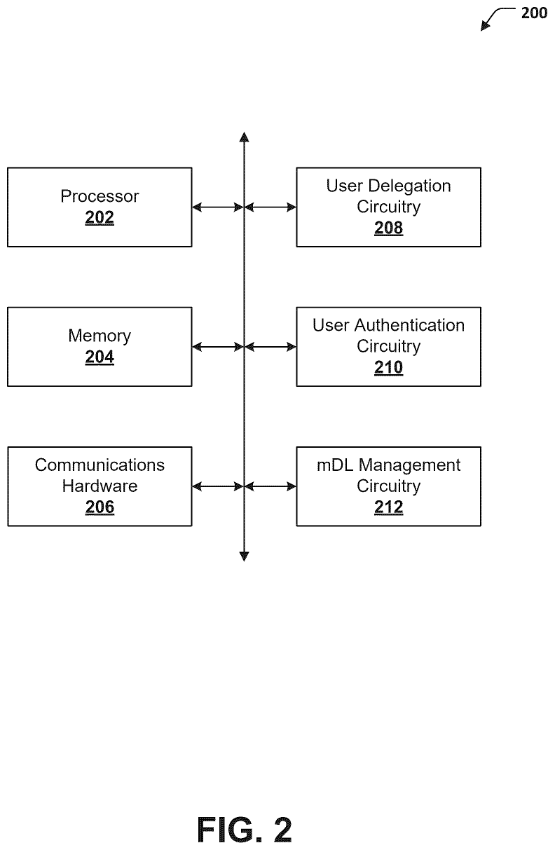

Example embodiments described herein may be implemented using any of a variety of computing devices or servers. To this end, FIG. 1 illustrates an example environment 100 within which various embodiments may operate. As illustrated, a delegated authority verification system 102 may receive and/or transmit information via communications network 104 (e.g., the Internet) with any number of other devices and/or systems, such as one or more of user devices 106A-106N and/or issuing authority (IA) systems 108A-108N. The delegated authority verification system 102 may be implemented as one or more computing devices or servers, which may be composed of a series of components. Particular components of the delegated authority verification system 102 are described in greater detail below with reference to apparatus 200 in connection with FIG. 2.

The delegated authority verification system 102 may be configured to store, integrate with, manage, and/or utilize one or more mobile driver's licenses (mDLs) associated with a respective user in order to facilitate the various operations described herein. As used herein, the term “mDL” covers various mobile (e.g., digital) identity credential types associated with a respective user including mobile driver's licenses and mobile identification cards. An mDL may be an electronically managed data structure configured to be accessed, processed, and/or otherwise utilized by the delegated authority verification system 102 for various user verification processes.

In this regard, an mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system 108A associated with a particular IA. An IA may be an entity that is legally entitled (or otherwise recognized as the relevant authority) to issue credentials such as driver's licenses and/or other identification cards. An IA system 108A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 108A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the delegated authority verification system 102 in compliance with various standards set forth by the American Association of Motor Vehicle Administrators (AAMVA). Additionally, or alternatively, in some embodiments, an mDL may be administered, managed, employed, and/or otherwise utilized by the delegated authority verification system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system 108A and one or more portions of credential data related to the mDL may be retrieved in real time, or near-real time, during a operation e.g., a delegated task) performed by the user. Additionally, or alternatively, once an mDL is issued to a user by a respective IA (e.g., by way of a corresponding IA system 108A), the mDL may be stored locally on a user device associated with the user (e.g., user device 106A) such that the mDL may be used without relying on a communications network (e.g., communications network 104). Additionally, or alternatively, in some embodiments, an mDL may be stored in a smart mobile wallet associated with the user and managed by the delegated authority verification system 102, and the mDL may be accessed and/or utilized by the user via the smart mobile wallet to execute various mDL-based operations.

In some examples, an IA may provision an mDL to a particular user device (e.g., user device 106A) associated with a user such that the mDL is associated with various user device identification data related to the particular user device (e.g., cryptographical identification data such as a public key). This may ensure that an mDL associated with a respective user cannot be transferred to multiple devices without authorization by the IA system (e.g., IA system 108A) and used in fraudulent transactions. Furthermore, associating an mDL with a particular user device (e.g., user device 106A) also enables the delegated authority verification system 102 and/or an IA system of an IA (e.g., IA system 108A) to verify that the intended user of the mDL is in possession of the mDL. Further still, associating an mDL with a particular user device (e.g., user device 106A) also ensures the safe transfer of sensitive credential data to and/or from the intended user of the mDL. In various examples, a user may store multiple copies of an mDL on multiple user devices (e.g., user devices 106A-106N). However, in such examples, each respective copy of the mDL may be cryptographically coupled to a respective user device by the IA system (e.g., IA system 108A) which provisioned the mDL. In this manner, each copy of the mDL can be independently verified against a respective user device to ensure that an mDL, or credential data associated with the mDL, cannot be transferred to unauthorized user devices.

An mDL may be associated with various mDL data security mechanisms used to ensure the validity of the mDL, authenticate an originating IA that issued the mDL, protect a user's personal data, and/or facilitate secure mDL-based operations (e.g., authentication operations). In this regard, an mDL may be associated with a mobile security object (MSO) and/or various public and private cryptographic key information. An MSO is an electronically managed data structure that enables the authentication of the accuracy and origin of various credential data associated with the mDL during mDL-based operations. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various operations. For example, if the credential data associated with the MSO indicates that the mDL is expired, the corresponding user may not be permitted to engage in one or more operations (e.g., delegated tasks) using the mDL.

Additionally, an mDL may be associated with various cryptographic key information (e.g., public/private key pair information) that may be utilized by the delegated authority verification system 102 to authenticate an originating IA that issued the mDL, verify one or more portions of credential data associated with an mDL, and/or facilitate various mDL-based operations (e.g., user authentication protocols, mDL data queries, or the like) for a user associated with the mDL. For example, an IA associated with a respective IA system 108A may be associated with a unique public key that may be utilized by the delegated authority verification system 102 to identify and/or authenticate the originating IA of a respective mDL. As such, in various examples, an mDL may be configured to store and/or point to the public key information associated with the IA from which the mDL was provisioned.

Additional details related to the execution of various operations related to one or more mDLs associated with a user by the delegated authority verification system 102 will be described in greater detail herein with reference to FIGS. 2-8.

The one or more user devices 106A-106N and the one or more IA systems 108A-108N may be embodied by any computing devices known in the art. The one or more user devices 106A-106N and the one or more IA systems 108A-108N need not themselves be independent devices, but may be peripheral devices communicatively coupled to other computing devices.

### Example Implementing Apparatuses

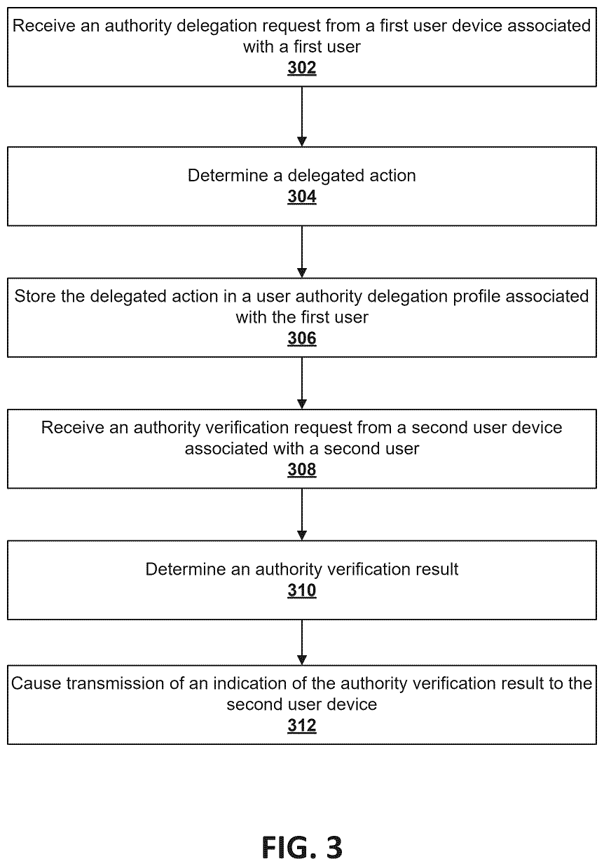

The delegated authority verification system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-7. As illustrated in FIG. 2, the apparatus 200 may include processor 202, memory 204, communications hardware 206, user delegation circuitry 208, user authentication circuitry 210, and mDL management circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

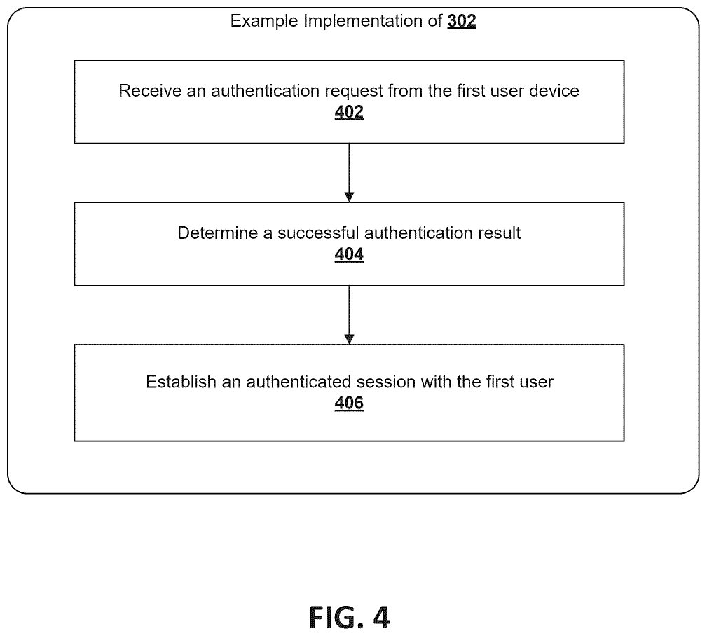

In addition, the apparatus 200 further comprises a user delegation circuitry 208 that determines, based on a delegation parameter set, a delegated action. In addition, user delegation circuitry 208 stores the delegated action in a user authority profile associated with a first user. The user delegation circuitry 208 may utilize processor 202, memory 204, or any other hardware component included in the apparatus 200 to perform these operations, as described in connection with FIGS. 3 and 4 below. The user delegation circuitry 208 may further utilize communications hardware 206 to gather data from a variety of sources (e.g., user device 106A through user device 106N, as shown in FIG. 1), and/or exchange data with a user, and in some embodiments may utilize processor 202 and/or memory.

In addition, the apparatus 200 further comprises a user authentication circuitry 210 that determines, based on an indication of a mDL, an authority verification result. In particular, user authentication circuitry 210 may leverage an authentication scoring model to ultimately determine an authority verification result. The user authentication circuitry 210 may utilize processor 202, memory 204, or any other hardware component included in the apparatus 200 to perform these operations, as described in connection with FIGS. 3 and 5-7 below. The user authentication circuitry 210 may further utilize communications hardware 206 to gather data from a variety of sources (e.g., user device 106A-106N or IA system 108A-108N, as shown in FIG. 1), and/or exchange data with a user, and in some embodiments may utilize processor 202 and/or memory 204.

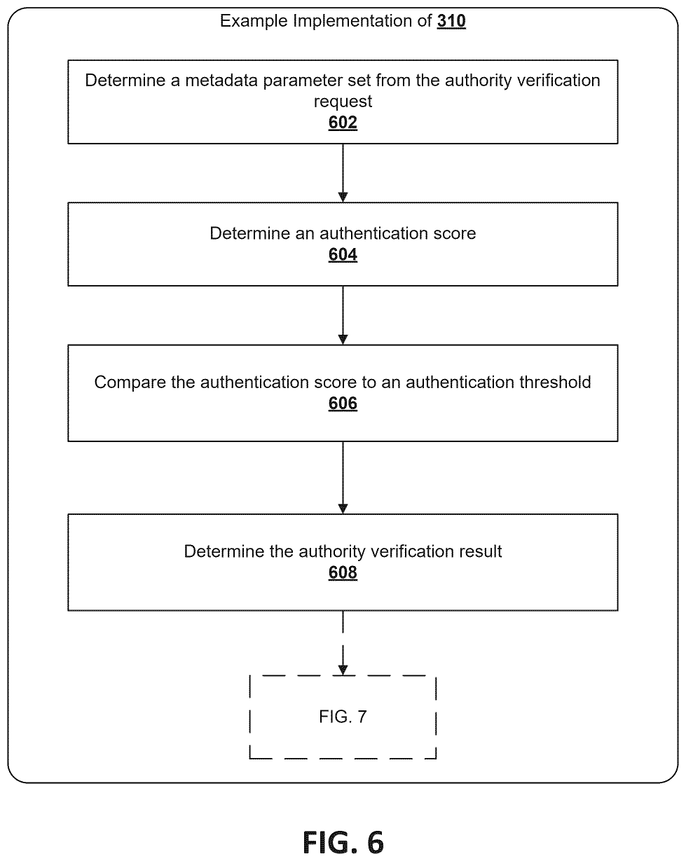

Further, the apparatus 200 further comprises mDL management circuitry 212. In some embodiments, the mDL management circuitry 212 may be configured to facilitate the execution of one or more mDL authentication and/or IA authentication operations for an enterprise associated with the delegated authority verification system 102. Additionally, the mDL management circuitry 212 may utilize processor 202, memory 204, or any other hardware component included in the apparatus 200 to perform these operations, as described in connection with FIGS. 4 and 6 below. The mDL management circuitry 212 may further utilize the communications hardware 206 to gather data from, or transmit data to, a variety of sources (e.g., the user devices 106A-106N, the IA systems 108A-108N, and/or any storage devices associated with the delegated authority verification system 102), and/or exchange data with a user. In some embodiments, the mDL management circuitry 212 may work in conjunction with the user authentication circuitry 210 in order to execute one or more of the methods described herein. For example, in some embodiments, the mDL management circuitry 212 may integrate with and/or otherwise leverage the user authentication circuitry 210 to facilitate the verification of a purported delegate based on a respective mDL associated with the purported delegate.

In various circumstances, an IA system (e.g., IA system 108A) that previously issued an mDL to a respective user may periodically update credential data associated with the mDL (e.g., new user contact information, updated credential restrictions, updated credential endorsements). As such, the mDL management circuitry 212 may be configured to retrieve and/or receive updated credential data associated with a user's mDL from an IA system (e.g., IA system 108A) and facilitate the updating of the user's mDL based on the updated credential data. For example, if an mDL associated with a user is stored in a smart mobile wallet being managed by the delegated authority verification system 102, the mDL management circuitry 212 may be configured to receive updated credential data associated with the user's mDL from the originating IA system (e.g., IA system 108A) and subsequently update the user's mDL in the smart mobile wallet based on the updated credential data.

In various examples, an IA (e.g., a branch of the DMV) associated with a respective IA system (e.g., IA system 108A) may enforce various mDL data freshness requirements associated with the mDLs the IA system provisions to users. In this regard, an MSO associated with a respective mDL may indicate a technical validity period associated with the mDL (e.g., a 30-day validity period). As such, the mDL management circuitry 212 may utilize the technical validity period indicated by the MSO to ensure that the credential data associated with the mDL stored on a user device (e.g., user device 106A) is updated and/or current. For example, if the mDL management circuitry 212 determines that the technical validity period indicated by the MSO has expired, the mDL may be invalidated until the credential data associated with the mDL is refreshed (e.g., updated, verified) by the IA system 108A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular user's legal credential, yet the user fails to have the legal credential (e.g., a corresponding physical credential) updated with said credential restrictions and/or credential endorsements. To address such problems, if the mDL management circuitry 212 determines that the technical validity period indicated by the MSO of the mDL has expired, the corresponding mDL may flag the mDL such that the mDL will fail various authentication protocols during an mDL-based operation (e.g., authenticating a purported delegate based on at least on an indication of their mDL).

In this regard, the mDL management circuitry 212 may be configured to facilitate the resetting of the technical validity period indicated by the MSO of the mDL in conjunction with a corresponding IA system (e.g., IA system 108A). Additionally or alternatively, the mDL management circuitry 212 may be configured to facilitate the updating and/or verification of the credential data associated with an mDL stored on a user device (e.g., user device 106A) each time the technical validity period associated with the MSO of the mDL is reset. This mDL data security mechanism ensures that the credential data associated with a user's mDL is always accurate and up to date.

As described herein, an mDL may be associated with various cryptographic key information (e.g., public/private key pair information) that may be utilized by the delegated authority verification system 102 to authenticate an originating IA that issued the mDL, verify one or more portions of credential data associated with an mDL, and/or facilitate various mDL-based operations (e.g., user authentication protocols, mDL data queries, or the like) for a user associated with the mDL. In this regard, the mDL management circuitry 212 may be configured to generate and/or transmit an IA authentication request comprising a public key associated with an IA to a corresponding IA system 108A in order to verify that a particular mDL was indeed provisioned by the IA associated with the IA system 108A.

In some examples, an mDL may only comprise (e.g., store, point to) identifying information related to a particular IA such that the mDL management circuitry 212 may be configured to first obtain a public key associated with the IA from a corresponding IA system 108A based on the identifying information. Once the public key information associated with the IA is obtained, the mDL management circuitry 212 may be configured to generate an IA authentication request comprising the public key of the IA and transmit the IA authentication request to the IA system 108A (e.g., via the communications network 104). As such, the mDL management circuitry 212 may be configured to receive, from an IA system (e.g., IA system 108A) and in response to the IA authentication request, one or more portions of data indicating whether the IA is a bona fide IA and/or whether the mDL indeed originated from the IA.

Once the mDL management circuitry 212 confirms the validity of the IA and/or confirms that a particular mDL associated with a user originated from the IA, the mDL management circuitry 212 may be configured to generate a digital token comprising cryptographical information (e.g., public key information) associated with the mDL and the user. Additionally, in some embodiments, the cryptographical information associated with the mDL and comprised in the digital token may be user device identification data by which a user device (e.g., user device 106A) of the respective user may be uniquely identified. In various examples, the mDL management circuitry 212 may generate and/or transmit the digital token to an IA system (e.g., IA system 108A) such that the IA system may decrypt the cryptographical information comprised in the digital token. In this manner, the IA system (e.g., IA system 108A) may authenticate (e.g., verify) one or more portions of credential data associated with the mDL and/or one or more portions of user device identification data associated with the user device (e.g., user device 106A). In this regard, the mDL management circuitry 212 may be configured to receive, from the IA system (e.g., IA system 108A) and in response to transmitting the digital token, one or more portions of data indicating whether the mDL and/or the user device (e.g., user device 106A) identified by the digital token is valid. Furthermore, in various examples, the mDL management circuitry 212 may be configured to receive, from the IA system (e.g., IA system 108A) and in response to transmitting the digital token, one or more portions of credential data associated with the mDL.

In some embodiments, the mDL management circuitry 212 may be configured to generate a digital token comprising cryptographical information (e.g., public key information) associated with an mDL and/or a user device (e.g., user device 106A) associated with a particular user in response to receiving an authority verification request that requests the verification of the particular user. In some embodiments, the mDL authentication request may be a request to authenticate an mDL associated with the particular user and thereby authenticate the identity of the particular user for one or more mDL-based operations (e.g., performing a delegated task). A respective mDL authentication request may comprise one or more of cryptographical information (e.g., public key information) associated with an mDL and/or a user device (e.g., user device 106A). Additionally or alternatively, a respective authority verification request may comprise one or more desired data elements (e.g., one or more desired portions of credential data) associated with the mDL, location data, user profile data, user account data, social media data, smart mobile wallet identification data, user device identification data, and/or the like associated with the particular user. In various examples, the mDL authentication request may be associated with one or more of users.

In various examples, an mDL validity response received from an IA system (e.g., IA system 108A) based on a digital token generated by the mDL management circuitry 212 may comprise the entirety of the credential data associated with the mDL of the particular user. Additionally or alternatively, in various other examples, an mDL validity response received from an IA system (e.g., IA system 108A) based on a digital token generated by the mDL management circuitry 212 may comprise a verification of the desired credential data associated with the mDL that was indicated by an mDL authentication request. Additionally or alternatively, in various other examples, an mDL validity response received from an IA system (e.g., IA system 108A) based on a digital token generated by the mDL management circuitry 212 may comprise a verification of the user device identification data associated with the user device (e.g., user device 106A) of the particular user. For example, the mDL validity response may verify that the user device currently associated with the mDL is the same (e.g., intended) user device that the mDL was originally provisioned to. In this manner, the delegated authority verification system 102 may be configured to confirm the validity of the mDL data of an mDL associated with a particular user order to authenticate the identity of the particular user. Additionally, this enables the delegated authority verification system 102 to confirm whether the intended user and/or user device (e.g., user device 106A) associated with the mDL is currently in possession of the mDL.

Although components 202-212 are described in part using functional language, it will be understood that the particular implementations necessarily include the use of particular hardware. It should also be understood that certain of these components 202-212 may include similar or common hardware. For example, the user delegation circuitry 208, user authentication circuitry 210, and mDL management circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the user delegation circuitry 208, user authentication circuitry 210, and mDL management circuitry 212 may leverage processor 202, memory 204, or communications hardware 206 as described above, it will be understood that any of user delegation circuitry 208, user authentication circuitry 210, and mDL management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that user delegation circuitry 208, user authentication circuitry 210, and mDL management circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-7, example flowcharts are illustrated that contain example operations implemented by example embodiments described herein. The operations illustrated in FIGS. 3-7 may, for example, be performed by delegated authority verification system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, user delegation circuitry 208, user authentication circuitry 210, and mDL management circuitry 212, and/or any combination thereof. It will be understood that user interaction with the delegated authority verification system 102 may occur directly via communications hardware 206, or may instead be facilitated by a separate computing device (e.g., any of user devices 106A-106N, shown in FIG. 1), and which may have similar or equivalent physical componentry facilitating such user interaction.

Turning first to FIG. 3, example operations are shown for verifying a delegate.

As shown by operation 302, the apparatus 200 includes means, such as processor 202, memory 204, communications hardware 206, or the like, for receiving an authority delegation request from a first user device (e.g., user device 106A, or the like) associated with a first user. The authority delegation request may be an electronic request that is transmitted from a computing device (e.g., user device 106A) associated with a user (e.g., a first user) that wishes to delegate authority to enable another individual (e.g., a third user) to perform an action (e.g., picking up children from school) on the user's (e.g., the first user's) behalf. The authority delegation request may comprise a delegation parameter set. The delegation parameter set may comprise one or more delegation parameters that describe a particular delegated action. In some embodiments, the delegation parameters may be selected or input by the user associated with the computing device that transmitted the authority delegation request. In some embodiments, the one or more delegation parameters may comprise an indication of a second user (e.g., a user identifier associated with the requested delegate), an indication of a task that the first user wishes to delegate (e.g., school pick-up), a delegation constraint (e.g., time constraint, such as an expiration date for the requested delegation of authority, automatic triggers, such as temporal or circumstantial triggers that terminate the requested delegation upon satisfaction of the automatic trigger, and/or the like). For example, the delegation parameters included an example delegation parameter set may include a user name george.smith, an indication of a school pick-up action, and a temporal trigger that deactivates the delegate's authorization to perform the school pick-up action three months following the reception of the authority delegation request.

In some embodiments, communications hardware 206 may receive the authority delegation request from a computing device associated with the first user (e.g., any one of user devices 106A-106N) via a network (e.g., communications network 104, shown in FIG. 1). In some embodiments, communications hardware 206 may store the received authority delegation request in a local storage device (e.g., memory 204, or the like). Additionally, or alternatively, communications hardware 206 may transmit the received authority delegation request to user delegation circuitry 208, such that user delegation circuitry 208 may promptly evaluate the received authority delegation request without retrieving the authority delegation request from a local storage device.

In some embodiments, the authority delegation request is transmitted during an authenticated session established between the delegated authority verification system 102 and a user device associated with the first user (e.g., any one of user devices 106A-106N). Turning now to FIG. 4, example operations are shown for establishing an authenticated session with a user (e.g., the first user).

As shown by operation 402, the apparatus 200 includes means, such as processor 202, memory 204, communications hardware 206, or the like, for receiving an authentication request from a first user device (e.g., user device 106A). The authentication request may be an electronic request that comprises one or more authentication factors associated with the user (e.g., the first user) that caused transmission of the authentication request (e.g., a username and password, a personal identification number (PIN), biometric data, and/or the like), one or more authentication factors associated with the computing device (e.g., user device 106A) that transmitted the authentication request (e.g., a device ID, such as an international mobile equipment identity (IMEI) or medium access control (MAC) address, an indication of the device model, geolocation data, and/or the like), and/or a time stamp indicating the date and time that the authentication request was generated by the computing device.

In some embodiments, the apparatus 200 (e.g., communications hardware 206) may receive the authentication request from a computing device (e.g., user device 106A) via a network (e.g., communications network 104, shown in FIG. 1). In some embodiments, communications hardware 206 may subsequently store the authentication request in a local storage device (e.g., memory 204, or the like). Additionally, or alternatively, communications hardware 206 may transmit the authentication request to user authentication circuitry 210 to enable real-time evaluation of the authentication request.

As shown by operation 404, the apparatus 200 includes means, such as processor 202, memory 204, user authentication circuitry 210, or the like, for determining an authentication result. The authentication result may indicate whether the user (e.g., the first user) associated with the authentication request is authenticated or not authenticated (e.g., verified or not verified based on a similarity between the received authentication data and baseline authentication data). For example, an authentication result may be a categorical value of “authenticated” or “not authenticated”, a numerical value of 1 for an authenticated user or 0 for a non-authenticated user, a Boolean value of “true” for an authenticated user or “false” for a non-authenticated user, or the like. An authentication result that corresponds to an authenticated user may indicate that there is a sufficient likelihood that the user that transmitted the authentication request from a computing device (e.g., user device 106A, or the like) is who they allege they are. Alternatively, an authentication result that corresponds to a non-authenticated user may indicate that there is an insufficient likelihood that the user that transmitted the authentication request from a computing device is who they allege they are.

In some embodiments, memory 204 may store baseline authentication data for each user that is registered for the authority delegation service provided by the delegated authority verification system 102. In this regard, user authentication circuitry 210 may retrieve the received authentication request and the baseline authentication data for the user and corresponding user device that transmitted the authentication request to the apparatus 200 (e.g., communications hardware 206) from a local storage device (e.g., memory 204, or the like). Subsequently, user authentication circuitry 210 may use any suitable method to evaluate the authenticity of each received authentication factor. In some embodiments, user authentication circuitry 210 may determine a partial authentication result for each received authentication factor. The partial authentication result may be a numerical score (e.g., a score between 0 and 1), a categorical result (verified or not verified, authenticated or not authenticated, or the like), and/or the like, that is produced by comparing a received authentication factor to its corresponding baseline authentication factor. For example, user authentication circuitry 210 may utilize an authentication factor evaluation set that may be stored in a local storage device, such as memory 204, to determine a partial authentication result for each received authentication factor. The authentication factor evaluation set may describe particular rules and/or conditions that user authentication circuitry 210 may utilize to determine how to evaluate each received authentication factor (e.g., the authentication factor evaluation set may describe a weight for each authentication factor, a similarity threshold to utilize when evaluating an authentication factor, or the like). For example, the authentication factor evaluation set may describe that a device ID authentication factor must exactly match a baseline authentication factor corresponding to the same device ID in order for user authentication circuitry 210 to determine a successful authentication result (e.g., a categorical successful authentication result). In another example, the authentication factor evaluation set may describe that the geolocation of the computing device that transmitted the received authentication request is within a particular radius (e.g., 1 kilometer) of a particular location (e.g., the first user's home address) in order for user authentication circuitry 210 to determine a successful authentication result. In yet another example, the authentication factor evaluation set may describe that fingerprint data may need to satisfy an 85% similarity score when the fingerprint data is compared to its corresponding baseline fingerprint data.

In some embodiments, user authentication circuitry 210 may use any suitable method to combine the partial authentication results to ultimately determine an authentication result. For example, user authentication circuitry 210 may calculate a weighted average of partial authentication scores where each authentication factor is weighted based on a weight that is indicated by the authentication factor evaluation set. Alternatively, user authentication circuitry 210 may use a trained machine learning model to combine each partial authentication result to ultimately determine an authentication result for the received authentication request. For example, the machine learning model may be trained using a large training dataset comprising authentication requests, which in turn comprises authentic and nonauthentic authentication factors that correspond to partial authentication results. As a result, the machine learning model may learn weights for each authentication factor, and thus may utilize these learned weights to combine the partial authentication results that are determined for each received authentication factor.

As shown by operation 406, the apparatus 200 includes means, such as processor 202, memory 204, communications hardware 206, user authentication circuitry 210, or the like, for establishing an authenticated session with the first user in response to a positive authentication result. An authenticated session may describe a period of time where the user associated with the authentication request is authenticated (e.g., in response to a successful authentication result determined above in relation to operation 404). In some embodiments, user authentication circuitry 210 may use any suitable method to generate a session token (e.g., a JSON Web Token (JWT)). For example, user authentication circuitry 210 may (i) create a header that comprises metadata about the token (e.g., the type of token (JWT), a signing algorithm, such as Hash-based Message Authentication Code (HMAC) with SHA-256, and/or the like), (ii) create a payload that comprises user data and/or token data (e.g., information about the user associated with the authentication request, such as a user identifier, and expiration time for the token, or the like), (iii) encode and combine the header and payload to allow for the data to be securely utilized in uniform resource locators (URLs), and (iv) sign the combined header and payload using a secret key and signing algorithm, where the signing creates a unique key based on the secret key and singing algorithm.

Upon the generation of the session token, user authentication circuitry 210 may leverage communications hardware 206 to cause transmission of the session token to the user device that corresponds with the received authentication request. For example, user authentication circuitry 210 may leverage communications hardware 206 to cause transmission of the generated session token to user device 106A via communications network 104, shown in FIG. 1. The transmission of the generated session token to a computing device enables the delegated authority verification system 102 to validate the token before granting the computing device (e.g., user device 106A, or the like) access to particular resources, such as an authority delegation request as described above in relation to operation 402. To this end, establishing an authenticated session with a user before receiving an authority delegation request enhances security because a tampered token would invalidate the generated signature, and thus cause termination of the authenticated session, which would in turn prohibit the transmission of an authority delegation request to the apparatus 200. Additionally, the use of tokens reduces the computational workload and enhances efficiency of the session authentication operations performed by the apparatus 200 because the use of tokens replaces the need for the apparatus 200 to periodically or continuously query a database with stored session information that would otherwise be required for authentication during an established session. Moreover, the apparatus 200 may require the establishment of an authenticated session before a user may request a delegation of authority. This requirement increases security by ensuring, based on the generated token's integrity, that only legitimate users can submit such requests (e.g., authority delegation requests) during the authenticated session. Thus, third parties that request to verify a purported delegate and users that wish to delegate authority for an action may trust that the delegations of authority stored by the apparatus 200 (e.g., memory 204) are secure, accurate, and untampered.

Returning to FIG. 3, as shown by operation 304, the apparatus 200 includes means, such as processor 202, memory 204, user delegation circuitry 208, or the like, for determining a delegated action. A delegated action may describe at least a particular action that a user (e.g., the first user) wishes to delegate to another user, an indication of the delegate (e.g., a user account associated with a username that corresponds to a user different than the user that transmitted the authority delegation request), one or more delegation constraints (e.g., an expiration date for the delegation, a frequency limit, or the like), and/or the like. For example, assume the first user wishes to delegate authority for a coworker (e.g., George Smith) to be authorized to pick-up the first user's children from elementary school. In this regard, the first user may transmit an authority delegation request on May 20, 2024 that comprises a delegation parameter set which in turn may comprise indications of a school pick-up operation, George Smith's username (e.g., George.Smith), and an expiration date of one year (e.g., Jun. 20, 2025).

In some embodiments, user delegation circuitry 208 may utilize any suitable technique to determine a delegated action from the received authority delegation request, such as optical character recognition (OCR), natural language processing (NLP), searching algorithms, and/or the like, to determine a delegated action. Continuing the above example, user delegation circuitry 208 may retrieve the authority delegation request from a local storage device (e.g., memory 204, or the like) and subsequently utilize NLP to identify the particular action (e.g., a school pickup operation), the user associated with the username included in the authority delegation request (e.g., George.Smith), one or more constraints (e.g., an expiration date of Jun. 20, 2025), and/or the like.

As shown by operation 306, the apparatus 200 includes means, such as processor 202, memory 204, communications hardware 206, user delegation circuitry 208, or the like, for storing the delegated action in a user authority delegation profile associated with the first user. The user delegation profile may be a data construct that is associated with a particular user (e.g., a first user, a second user, a third user, or the like) that includes delegated actions (e.g., active delegated actions, expired delegated actions, and/or the like) that were determined from an authority delegation request that was received from a computing device (e.g., user device 106A, or the like) during an established authenticated session between the apparatus 200 and the computing device.

In some embodiments, upon determining the delegated action from the delegation parameters set, user delegation circuitry 208 may store the delegated action within an already existing user delegation profile that is in turn stored within a local storage device (e.g., memory 204, or the like) and/or an external storage device (e.g., a data repository that may be embodied by one or more DAS devices (such as hard drives, solid-state drives, optical disc drives, or the like) or may alternatively comprise one or more NAS devices independently connected to a communications network (e.g., communications network 104). Alternatively, if a user delegation profile is not already established for a particular user, user delegation circuitry 208 may generate a user delegation profile that comprises the delegated action and subsequently store the generated user delegation profile within a local storage device and/or an external storage device. For example, user delegation circuitry 208 may leverage communications hardware 206 to transmit the delegated action to an external storage device, such that the external storage device may generate a user delegation profile associated with the user that may store the delegated action. In some embodiments, the user delegation profile may be linked to a user account for a corresponding user. Additionally, or alternatively, the user delegation profile may include user information such that the correct user delegation profile may be identified for a corresponding user (e.g., the first user).

As shown by operation 308, the apparatus 200 includes means, such as processor 202, memory 204, communications hardware 206, or the like, for receiving an authority verification request from a second user device. The second user device may be associated with a second user different than the first user. The second user may be an entity (e.g., an individual, a business, an organization, or the like) that wishes to verify a purported delegate. The authority verification request may be an electronic request that comprises an indication of a mobile driver's license (mDL) associated with a third user (e.g. a purported delegate) and the action that the purported delegate requests to perform (e.g., a school pickup operation). For example, the indication of the mDL may be a quick-response (QR) code, such that the QR code includes information associated with the mDL. In some embodiments, the indication of the mDL (e.g., a QR code) may include or point to (i) data associated with the IA that provisioned the mDL and (ii) data associated with a respective user (e.g., the third user) including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user, such that the apparatus 200 may transmit the indication of the mDL to an issuing authority (IA) that provisioned the mDL for verification.

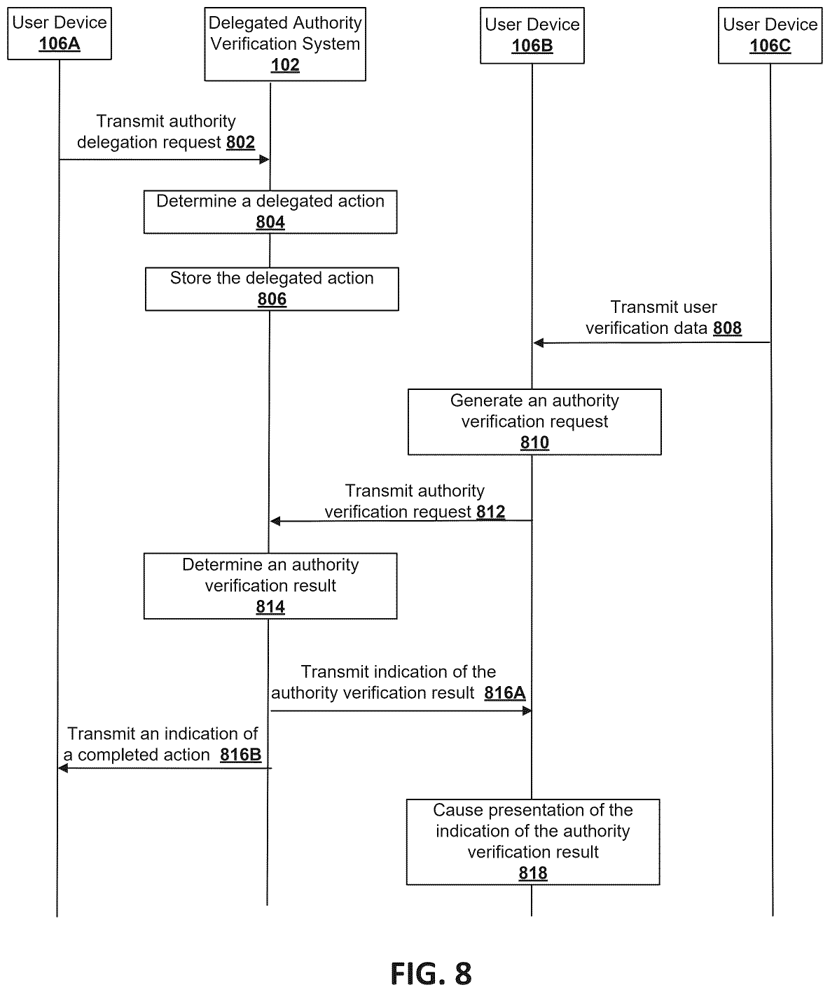

In some embodiments, the apparatus 200 may receive various user verification data (e.g., the indication of the mDL, the requested action, or the like) from the second user device (e.g., a computing device, such as user device 106B, associated with a third-party verifier). The second user device may securely acquire (e.g., via short-range wireless communication) user verification data associated with the purported delegate by receiving the user verification data from a computing device (e.g., a third user device, such as user device 106C) associated with the third user (e.g., the purported delegate). For example, the third user device may transmit the indication of the mDL or mDL data to the second user device via short-range wireless communication (e.g., Near Field Communication (NFC), or the like). Thereafter, the authority delegation request may be automatically generated by the second user device based on the received data (e.g., an indication of the mDL, device information, the requested action, or the like), such that the authority delegation request comprises the necessary data for the apparatus 200 to promptly verify the purported delegate based on the authority verification request and/or the user verification data included in the authority verification request. The particular interactions between the computing device associated with the purported delegate, the computing device associated with the third-party verifier, the computing device associated with the delegator, and the delegated authority verification system 102 are described in greater detail below in relation to FIG. 8.

The use of short-wave technology to transmit the indication of the mDL (or data that is ultimately used to generate the indication of the mDL) from a computing device associated with the purported delegate to a computing device associated with the third-party verifier allows for increased security by ensuring the security of the data (e.g., user verification data) that is utilized by the apparatus 200 for verifying a purported delegate. For example, since NFC operates at a short range (e.g., approximately less than 4 centimeters), this requires the purported delegate to be present (e.g., close in proximity to the third-party verifier) to exchange user verification data. Thus, the third-party verifier may be confident that the information (e.g., user verification data, such as the indication of the mDL) that is utilized to determine the ultimate authority verification result is associated with the purported delegate that the third-party verifier is currently interacting with. Moreover, since the purported delegate must be within close proximity to the third-party verifier to transmit the indication of the mDL via short-range communication, the third-party verifier is more capable to detect bad actors that wish to intercept the communication because a bad actor would be required to be within a close proximity to the third-party verifier and purported delegate to intercept the short-range communication.

In some embodiments, the authority verification request may not comprise an indication of a mDL. In this regard, the apparatus 200 may leverage user authentication circuitry 210 to determine an authority verification result based on a standard method of verification. A standard method of verification may refer to any suitable method of verifying a purported delegate that is not reliant upon the use a mDL or indication of a mDL, such as biometric authentication, multifactor authentication, and/or the like.

In some embodiments, the authority verification request may be received by the apparatus 200 via a computing device associated with a second user that wants to verify a purported delegate. For example, communications hardware 206 may receive the authority verification request from a computing device associated with the second user (e.g., user device 106N, or the like) via a network (e.g., communications network 104, shown in FIG. 1). Upon receiving the authority verification request, communications hardware 206 may store the authority verification request within a local storage device (e.g., memory 204, or the like). Alternatively, communications hardware 206 may immediately transmit the authority verification request to user authentication circuitry 210 and/or mDL management circuitry for subsequent analysis.

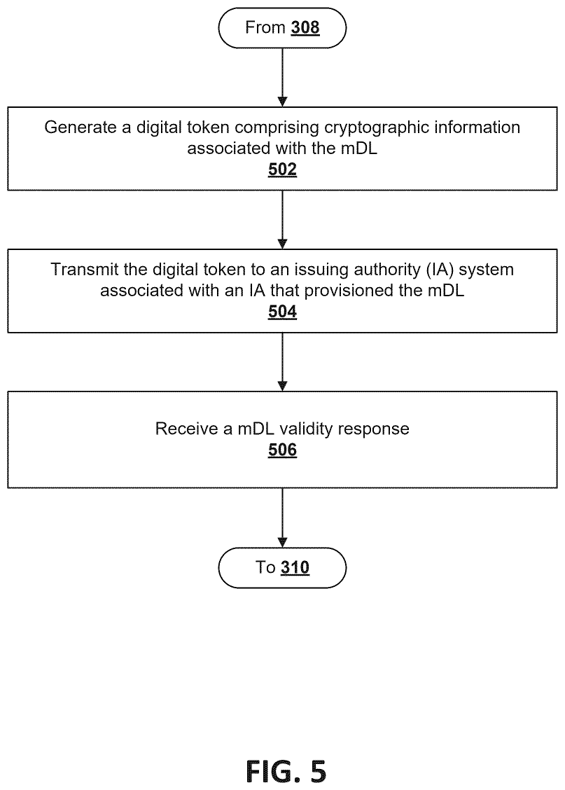

In some embodiments, upon receiving the authority verification request, the apparatus 200 may transmit information that is derived from the indication of the mDL to the IA that provisioned the mDL for verification. Turning next to FIG. 5, example operations are shown for using an indication of a mDL to receive an mDL validity response.

As shown by operation 502, the apparatus 200 includes means, such as processor 202, memory 204, communications hardware 206, mDL management circuitry 212, or the like, for generating a digital token comprising cryptographic information associated with the mDL. In some embodiments, the generated token may comprise one or more of cryptographical information associated with the mDL, cryptographical information associated with a computing device (e.g., user device 106A) to which the mDL corresponds, desired credential data associated with the mDL, location data, user profile data, user account data, social media data, or smart wallet identification data. Additionally, in some embodiments, the cryptographic information associated with the mDL may be associated with user device identification data by which a user device (e.g., user device 106N) of the purported delegate may be uniquely identified.

In some embodiments, mDL management circuitry 212 may use any suitable method, such as using a JWT token generation technique, or the like, to generate the digital token. For example, mDL management circuitry 212 may (i) create a header that comprises metadata about the token (e.g., the type of token (JWT), a signing algorithm, such as Hash-based Message Authentication Code (HMAC) with SHA-256, and/or the like), (ii) create a payload that comprises mDL data and/or token data (e.g., information about the mDL included in the indication of the mDL, expiration time for the token, or the like), (iii) encode and combine the header and payload, and (iv) sign the combined header and payload using a secret key and signing algorithm, where the signing creates a unique key based on the secret key and singing algorithm.

As shown by operation 504, the apparatus 200 includes means, such as processor 202, memory 204, communications hardware 206, mDL management circuitry 212, or the like, for transmitting the digital token to an IA system (e.g., IA system 108A, or the like) associated with the IA that provisioned the mDL. In some embodiments, the indication of the mDL received in operation 308 may include an indication of the IA that provisions the mDL. As a result, mDL management circuitry may use the indication of the IA system that provisioned the mDL (e.g., IA system 108A) to identify the IA that provisions the mDL and subsequently leverage communications hardware 206 to transmit the digital token to a computing device associated with the identified IA (e.g., IA system 108A). For example, mDL management circuitry 212 may leverage communications hardware 206 to transmit the digital token to an IA system (e.g., IA system 108A) that provisioned the mDL to a purported delegate (e.g., the third user), such that the IA system (e.g., IA system 108A) may decrypt and verify the cryptographic information comprised in the digital token. In this manner, the IA system (e.g., IA system 108A) may e.g., verify one or more portions of credential data associated with the mDL and/or one or more portions of user device identification data associated with the user device (e.g., user device 106N, or the like) of the third user.

As shown by operation 506, the apparatus 200 includes means, such as processor 202, memory 204, communications hardware 206, or the like, for receiving an mDL validity response. In some embodiments, the mDL validity response may indicate whether the token generated based on the indication of the mDL (e.g., the token generated in operation 502) includes verified credential data. Furthermore, in some examples, the mDL validity response may also indicate particular verified credential data associated with the purported delegate and/or verified user device identification data related to the third user device that generated the indication of the mDL (e.g., user device 106A, or the like). In some embodiments, the mDL validity response may be a categorical value of “verified” or “not verified”, a numerical value of 1 for a verified mDL or 0 for non-verified mDL, a Boolean value of “true” for a verified mDL or “false” for a non-verified mDL, etc, for a particular credential data.

In some embodiments, communications hardware 206 may receive the mDL validity response from the IA system (e.g., IA system 108N, or the like) that provisioned the mDL that corresponds to the indication of the mDL via a network (e.g., communications network 104, shown in FIG. 1). Upon receiving the mDL validity response, communications hardware 206 may store the mDL validity response in a local storage device (e.g., memory 204, or the like). Additionally, or alternatively, communications hardware 206 may immediately transmit the mDL validity response to user authentication circuitry 210, such that user authentication circuitry 210 may utilize the mDL validity response to determine an authority verification result, which is described in further detail below in relation to operation 310 and FIG. 6.

Returning to FIG. 3, as shown by operation 310, the apparatus 200 includes means, such as processor 202, memory 204, communications hardware 206, user authentication circuitry 210, or the like, for determining an authority verification result identifying whether the third user (e.g., a purported delegate) is authorized to perform the delegated action. In this regard, the authority verification result may indicate whether the delegated authority verification system 102 has successfully verified a purported delegate. For example, the authority verification result may be a categorical result, such as satisfied or not satisfied, tier 1/tier 2/tier 3/, or the like, that indicates whether a purported delegate is a legitimate delegate. In some embodiments, the authority verification result may be based at least on the indication of the mDL (e.g., the mDL validity response provided by the IA system that provisioned the mDL). Additionally, the authority verification result may be further based on metadata associated with the received authority verification request. Determining an authority verification result from at least on an indication of the mDL and/or metadata associated with the authority verification request is described in greater detail below in relation to FIG. 6.

Turning now to FIG. 6, example operations are shown for using an authentication score to determine an authority verification result.

As shown by operation 602, the apparatus 200 includes means, such as processor 202, memory 204, communications hardware 206, user authentication circuitry 210, or the like, for determining a metadata parameter set based on the authority verification request. The metadata parameter set may include parameters that describe metadata associated with the authority verification request, such as a time stamp associated with the reception of the authority delegation request, device information associated with the authority delegation request, and/or the like. In some embodiments, user authentication circuitry 210 may use any suitable technique and/or method to determine one or more metadata parameters from the authority verification request, such as (i) logging the exact time and date when communications hardware 206 received the authority verification request, (ii) capturing the internet protocol (IP) address associated with the computing device that transmitted the authority verification request (e.g., user device 106A, or the like), (iii) capturing the operating system and/or application utilized by the computing device to transmit the authority verification request, and/or the like.

Upon determining a metadata parameter set, user authentication circuitry 210 may store the metadata parameter set in a local storage device (e.g., memory 204, or the like). Additionally, or alternatively, user authentication circuitry 210 may transmit the metadata parameter set to an authentication scoring model so that the authentication scoring model may promptly determine an authentication score based at least in part on the metadata parameter set.

As shown by operation 604, the apparatus 200 includes means, such as processor 202, memory 204, communications hardware 206, user authentication circuitry 210, or the like, for determining an authentication score. In some embodiments, the authentication score may be a numerical score that indicates the likelihood that a purported delegate is a legitimate delegate. For example, the authentication score may be a numerical score between the values of 0 and 1, where a value closer to 0 indicates that the purported delegate is not a legitimate delegate and a value closer to 1 indicates that the purported delegate is a legitimate delegate or vice versa. In some embodiments, the authentication score may not be a numerical score, but rather a categorical result, such as tier 1/tier 2/tier 3, green, yellow, red, or some other type of categorical result.

In some embodiments, the authentication score may be determined based on the mDL validity response, metadata parameter set, and/or the like. Alternatively, if a mDL was not included in the authority verification request, the authentication score may be determined based on the metadata parameter set and/or the results associated with any completed standard verification methods (e.g., a successfully biometric authentication factor comparison, a successful PIN input, or the like). In some embodiments, user authentication circuitry 210 may leverage an authentication scoring model to determine an authentication score for a particular authentication request. The authentication scoring model may be a rules-based model, machine learning model, or the like. For example, a rules-based authentication scoring model may rely upon a set of authentication scoring rules that are determined by the entity offering the delegate verification service that is provided by delegated authority verification system 102. In such an embodiment, the set of authentication scoring rules may be stored in a local storage device (e.g., memory 204, or the like). As such, the set of authentication scoring rules may describe a partial authentication score to assign a particular parameter (e.g., a parameter included in the metadata parameters set), mDL validity response, or the like, based on the value or result associated with a particular parameter or mDL validity response. Moreover, the set of authentication scoring rules may also describe weights for each input for the authentication scoring model, such that the authentication score is weighted accordingly to account for the various importances of the plurality of different inputs (e.g., the metadata parameter set, the mDL validity response, and/or the like) in the authentication scoring model.

In some embodiments, the authentication scoring model may be a machine learning model (e.g., a logistic regression model). For example, the machine learning authentication scoring model may be iteratively trained on a corpus of labeled training data. In some embodiments, the corpus of training data may include a plurality of data elements that comprise labels that indicate whether a particular data element corresponds to failed authentication attempts or successful authentication attempts. During training, the machine learning authentication scoring model may learn a variety of weights for a plurality of input features (e.g., particular metadata parameters that may be included in a metadata parameter set). In particular, the machine learning authentication scoring model may learn corresponding weights for time-based features associated with the time the authority verification request was received (e.g., hour of the day, day of the week, month of the year, or the like), mDL features (e.g., license status, days until expiration, presence of flags or alerts), network features (e.g., known/unknown IP address, network type such as Wi-Fi or mobile data, or the like), device features (e.g., a known user device, or the like), location features (e.g., distance from a known location, or the like), or the like. To this end, user authentication circuitry 210 may retrieve the metadata parameter set and mDL validity response from a local storage device (e.g., memory 204, or the like) and subsequently provide the metadata parameter set and mDL validity response to the machine learning authentication scoring model, which enables the machine learning authentication scoring model to generate a weighted authentication score based on its learned weights for each input feature.

As shown by operation 606, the apparatus 200 includes means, such as processor 202, memory 204, user authentication circuitry 210, or the like, for comparing the authentication score to an authentication threshold. The authentication threshold may be a predetermined authentication threshold. For example, the entity that is providing the delegate verification service offered by the delegated authority verification system 102 may store a set of predetermined authentication thresholds in a local storage device (e.g., memory 204, or the like). The set of predetermined authentication thresholds may describe a value or category that a particular authentication score must satisfy (e.g., by comparing the authentication score with the predetermined authentication threshold) in order to produce a particular authentication verification result (e.g., a successful authentication result or a negative authentication result). In some embodiments, each particular authentication threshold is based on a particular parameter associated with the authority verification request, mDL validity response, or the like, such as the particular delegated task (e.g., school pickup operation, check-writing, or the like). Alternatively, the authentication threshold may not be a predetermined authentication threshold, but rather a learned authentication threshold that was learned during model training. As a result, the learned authentication threshold may inherently account for the parameters input to the authentication scoring model.

As shown by operation 608, the apparatus 200 includes means, such as processor 202, memory 204, user authentication circuitry 210, or the like, for determining the authority verification result. The authority verification result may indicate whether the delegated authority verification system 102 has successfully verified a purported delegate. In this regard, the authority verification result may be a categorical result, such as satisfied or not satisfied, tier 1/tier 2/tier 3/, or the like, that indicates whether a purported delegate is a legitimate delegate. In some embodiments, the authority verification result may be based at least on the indication of the mDL (e.g., an mDL validity response provided by an IA system that provisioned the mDL). Additionally, the authority verification result may further account for metadata associated with the received authority verification request.

In some embodiments, the authority verification result may be based on whether the authentication score satisfies the authentication threshold. As a result, user authentication circuitry 210 may determine a successful or unsuccessful authority verification result based on whether the authentication threshold was satisfied in operation 606. For example, assume an authentication score associated with an authority verification request is determined to be 0.90 and the authentication threshold (e.g., a predetermined authentication threshold, learned authentication threshold, or the like) is 0.75. As a result, since the determined authentication score satisfies the authentication threshold (e.g., via a comparison of the authentication score with the authentication threshold), user authentication circuitry 210 may determine a successful authority verification result. In some embodiments, in response to user authentication circuitry 210 determining a successful authentication result, the procedure may advance to operation 312 (described below).

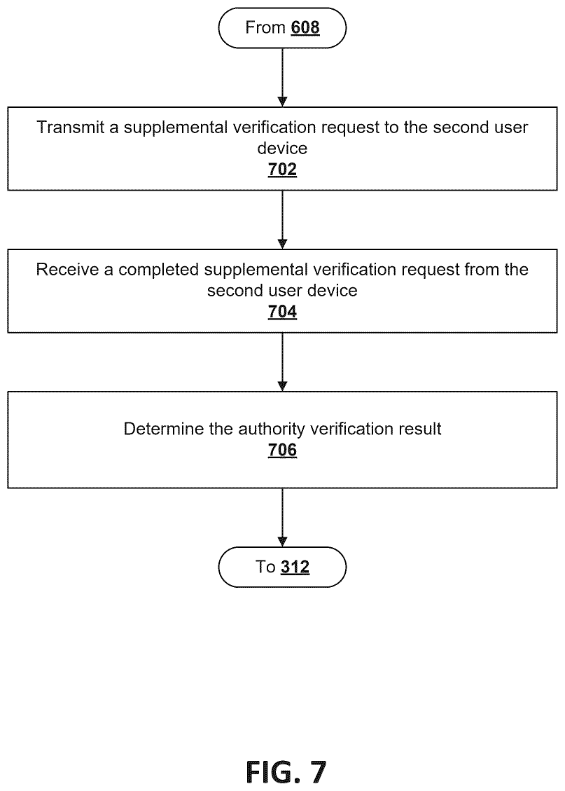

Alternatively, if an authentication score does not satisfy an authentication threshold, user authentication circuitry 210 may determine an unsuccessful authority verification result. In some embodiments, in response to an unsuccessful authority verification result, the procedure may advance to operation 312. Additionally, or alternatively, the apparatus 200 (e.g., user authentication circuitry 210) may cause performance of a supplemental verification operation. Turning next to FIG. 7, example operations are shown for using a supplemental verification request to determine an updated authority verification result.

As shown by operation 702, the apparatus 200 includes means, such as processor 202, memory 204, communications hardware 206, user authentication circuitry 210, or the like, for transmitting a supplemental verification request. A supplemental verification request may be an electronic request that includes instructions for a user associated with an unsuccessful authority verification result to perform a supplemental verification operation that may be used to verify the purported delegate's identity. The supplemental verification operation may be any suitable verification operation, such as a standard method of authentication, that gathers authentication data associated with the purported delegate, such as capturing the purported delegate's biometric data (e.g., fingerprint, face scan, voice print, and/or the like), entering a one-time password, entering a personal identification number (PIN) associated with the purported delegate, and/or the like.

In some embodiments, the particular supplemental verification operation(s) requested to be performed by the apparatus 200 may be determined based on the authentication score that corresponds with the authority verification request (e.g., an authority verification request that is associated with the unsuccessful authority verification result). In some embodiments, a local storage device, such as memory 204, may store supplemental verification operation rules that describe a particular verification operation to perform based on the authentication score. The supplemental verification operation rules may be predetermined by the entity that is providing the delegate verification service provided by the delegated authority verification system 102. User authentication circuitry 210 may retrieve the supplemental verification operation rules from memory 204 to determine a particular supplemental verification operation to be performed and subsequently generate a supplemental verification request that requests performance of the determined supplemental verification operation.

In some embodiments, user authentication circuitry 210 may retrieve the supplemental verification request from a local storage device (e.g., memory 204, or the like). Subsequently, user authentication circuitry 210 may leverage communications hardware 206 to transmit the supplemental verification request to the entity that desires to authenticate a purported delegate. For example, user authentication circuitry 210 may leverage communications hardware 206 to transmit the supplemental verification request to a computing device associated with a second user (e.g., user device 106A, or the like) that instructs the second user to gather additional authentication information from the purported delegate (e.g., a third user). Although the second user device (e.g., a computing device associated with a second user, such as an individual verifying a purported delegate) is described herein to receive the transmitted supplemental verification request, it shall be understood that the third user (e.g., the purported delegate) may additionally or alternatively receive the supplemental verification request, and thus interact and provide (e.g., as described below in relation to operation 704) their own supplemental authentication data directly to the apparatus 200 via their own respective computing device.

As shown by operation 704, the apparatus 200 includes means, such as processor 202, memory 204, communications hardware 206, or the like, for receiving a completed supplemental verification request from the second user device (e.g., user device 106A, or the like). In some embodiments, the completed supplemental verification request is an electronic request that includes authentication information about a purported delegate (e.g., the third user) that was requested in the supplemental verification request described above in relation to operation 702.

In some embodiments, communications hardware 206 may receive the completed supplemental verification request from the second user device (e.g., a computing device, such as user device 106A, associated with the second user) via a network (e.g., communications network 104, shown in FIG. 1. Alternatively, communications hardware 206 may receive the completed supplemental verification request directly from the computing device (e.g., a user device, such as user device 106N, or the like) associated with the purported delegate. In some embodiments, upon receiving the completed supplemental verification request, communications hardware 206 may store the completed supplemental verification request in a local storage device (e.g., memory 204, or the like). Additionally, or alternatively, communications hardware 206 may transmit the received completed supplemental verification request to user authentication circuitry 210 for further analysis (e.g., verifying the authentication information included in the supplemental authentication request).

As shown by operation 706, the apparatus 200 includes means, such as processor 202, memory 204, user authentication circuitry 210, or the like, for determining an updated authority verification result. In some embodiments, user authentication circuitry 210 may retrieve the supplemental authentication request from a local storage device (e.g., memory 204) and subsequently extract the included authentication information (e.g., a PIN, one-time password, biometric data, and/or the like). The extracted authentication information may be compared to stored baseline authentication data (e.g., known authentic data that was captured and stored in a local storage device in association with the purported delegate). In some embodiments, user authentication circuitry 210 may use any suitable method to perform the comparison of the received authentication information and the baseline authentication data. For example, assume the completed supplemental verification request included a PIN associated with the purported delegate. As a result, user authentication circuitry 210 may retrieve from memory 204 the baseline PIN stored in association with the purported delegate and subsequently compare the baseline PIN to the PIN included in the completed supplemental verification request.

In some embodiments, upon a successful verification of the received authentication information, user authentication circuitry 210 may determine a successful authority verification result. Alternatively, upon an unsuccessful verification of the received authentication information, user authentication circuitry 210 may determine an unsuccessful authority verification result.

Returning to FIG. 3, as shown by operation 312, the apparatus 200 includes means, such as processor 202, memory 204, communications hardware 206, or the like, for causing transmission of an indication of the authority verification result to the second user device. In some embodiments, if the operations outlined by FIG. 7 were performed, an indication of the updated authority verification result may be transmitted to the second user device instead of or in parallel with the transmission of the indication of the authority verification result. The transmission of the indication of the updated authority verification result may follow a similar procedure as described below in relation to the transmission of an indication of the authority verification result.

In some embodiments, the indication of the authority verification result may be any suitable indication for promptly notifying the second user device of the determined authority verification result, such that the entity that initiated the verification may perform an appropriate action (e.g., denying performance of a task to a purported delegate, allowing performance of a delegated action to a legitimate purported delegate, and/or the like) in real-time. For example, the indication of the authority verification result that is transmitted to the second user device may be a push notification, a text message, email notification, an in-app notification, haptic feedback, a voice call, and/or the like.

In some embodiments, communications hardware 206 may transmit the indication of the authority verification result (e.g., a text message) to the second user device (e.g., user device 106A, or the like) via communications network 104. Moreover, communications hardware 206 may transmit a notification (e.g., a completed action notification or a failed action notification) to one or more user devices (e.g., any one of user devices 106A-106N) associated with the first user concurrently or immediately thereafter the transmission of the indication of the authority verification result, such that the first user is notified in real-time of any delegated actions taken or attempted on their behalf. Alternatively, upon transmitting the indication of the authority verification result, communications hardware 206 may receive a response that indicates whether the delegated action was performed. Accordingly, based on the received response, a corresponding electronic notification may be provided to the first user that notifies the first user of the authority verification result and whether the delegated action was successfully performed by the purported delegate. For example, in response to a successful authentication result, communications hardware 206 may transmit an electronic completed action notification that includes an indication of the third user (e.g., the delegate), the delegated action, the authority verification result, the time the delegated action occurred, and/or the like. Alternatively, in response to an unsuccessful authentication result, communications hardware 206 may transmit an electronic failed action notification to one or more user devices associated with the first user that includes an indication of the third user (e.g., the purported delegate), the delegated action, the authority verification result, the time the attempted delegated action occurred, and/or the like.

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

FIG. 8 shows a swim lane diagram illustrating example operations (e.g., as described above in connection with FIGS. 3-7) performed by components of the environment depicted in FIG. 1 to produce various benefits of the implementations described herein. The operations shown in the swim lane diagram performed by the first user device are shown along the line extending from the box labeled “user device 106A”, operations performed by delegated authority verification system 102 are shown along the line extending from the box labeled “Delegated Authority Verification System 102”, operations performed by the second user device are shown along the line extending from the box labeled “User Device 106B”, and operations performed by the third user device are shown along the line extending from the box labeled “User Device 106C”. Operations impacting multiple devices, such as data transmission between the devices, are shown using arrows extending between these lines. Generally, these operations are ordered temporally with respect to one another. However, it will be appreciated that the operations may be performed in other orders from those illustrated in FIG. 8.

At operation 802, user device 106A may transmit an authority delegation request to the delegated authority verification system 102. At operation 804, delegated authority verification system 102 may determine a delegated action based on the received authority delegation request. At operation 806, delegated authority verification system 102 may store the determined delegated action in a user delegation profile associated with the first user (e.g., the delegator). At operation 808, the third user (e.g., a purported delegate) may transmit user verification data (e.g., an indication of the mDL, the requested action, and/or the like) to the second user device (e.g., user device 106B). At operation 810, the second user device may generate an authority verification request based on the transmitted user verification data. At operations 812, the second user device may transmit the authority verification request to the delegated authority verification system 102. At operation 814, the delegated authority verification system 102 may determine an authority verification result. At operation 816A, the delegated authority verification system 102 may transmit an indication of the authority verification result to the second user device. At operation 816B, the delegated authority verification system 102 may transmit an indication of a completed action (e.g., a completed action notification) to the first user device concurrently with the transmission described at operation 816A or immediately thereafter, such that the first user device may receive a real-time notification indicating that a purported delegate verification has been performed by the apparatus 200. At operation 818, the second user device may cause presentation of the indication of the authority verification result.

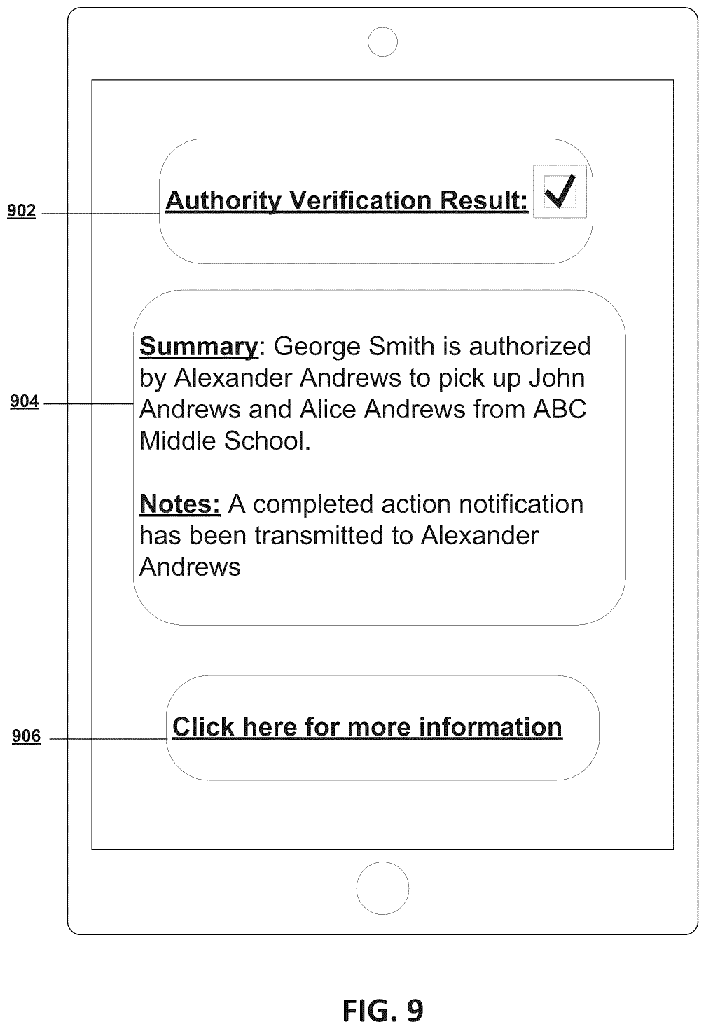

Turning to FIG. 9, a graphical user interface (GUI) is provided that illustrates an example presentation of an indication of the authority verification result on a computing device (e.g., user device 106A, or the like). As noted previously, delegated authority verification system 102 may directly transmit an indication of the authority verification result to the computing device that transmitted the authority verification request (e.g., the second user device) by leveraging communications hardware 206 to transmit e.g., a message, notification, or the like, to the second user device via communications network 104, shown in FIG. 1.

Authority verification result indicator 902 may be automatically displayed on a computing device associated with the second user. Alternatively, authority verification result indicator 902 may be displayed in response to a user interacting with the transmitted message. For example, the checkmark included in authority verification result indicator 902 may be displayed if a user hovers a cursor over the bolded and underlined text “Authority Verification Result.” A visual indicator, such as authority verification result indicator 902 blinking, may prompt the user to click or otherwise interact with authority verification result indicator 902. Similarly, text summary 904 may be automatically displayed or text summary 904 may be displayed in response to a user interacting with the transmitted message, such as hovering over the bolded and underlined text. In addition, a visual indicator, such as text summary 904 blinking, may prompt a user to hover a curser or click the bolded and underlined text. Lastly, additional information prompt 906 may blink or comprise text that instructs the user to interact with the additional information prompt 906 to reveal additional information about the delegation (e.g., an image of the delegate from the mDL, a time log of the performed delegation, contact information for the delegating party, and/or the like). It should be appreciated that the example presentation of an indication of the authority verification result on a computing device (e.g., user device 106A, or the like) is just one of a plurality of different example presentations. For example, the above-described information, such as the authority verification result indicator 902 may be displayed and/or provided in a myriad of other ways, such as via haptic feedback, audio responses, other types of visual cues that indicate categorical results (e.g., green=verified, red=not verified, or the like), or the like.

### CONCLUSION

As described above, example embodiments provide methods and apparatuses that enable improved verification of purported delegated authorities. Example embodiments thus provide tools that overcome the problems faced by conventional methods to delegate authority (e.g., orally delegating authority, handwritten delegations of authority, or the like). By avoiding the use of conventional delegations of authority methods, example embodiments thus save time and resources, while also providing a secure audit trail of delegations of authority, and thus eliminate the possibility of human error that has been unavoidable in the past. Moreover, embodiments described herein avoid intensive document analysis techniques to verify the authenticity of documents that memorialize delegations of authority. Finally, by automating verification operations that have historically required lengthy analysis, the speed and consistency of the evaluations performed by example embodiments unlocks many potential new functions that have historically not been available, such as the ability to conduct near-real-time dispute resolution.

As these examples all illustrate, example embodiments contemplated herein provide technical solutions that solve real-world problems faced during a delegate verification process. And while verifying purported delegated authorities has been an issue for decades, the recently exploding amount of data made available by recently emerging technology today has made this problem significantly more acute, as the demand for efficient and accurate verification techniques has grown significantly even while the complexity of fraud performed by bad actors has itself increased. At the same time, the recently arising ubiquity of digital identification technology has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for verifying a delegate, the method comprising:
receiving, by communications hardware, an authority delegation request from a first user device associated with a first user, wherein the authority delegation request comprises a delegation parameter set;
determining, by a user delegation circuitry and based on the delegation parameter set, a delegated action;
storing, by the user delegation circuitry, the delegated action in a user authority delegation profile associated with the first user;
receiving, by the communications hardware, an authority verification request from a second user device associated with a second user, wherein the authority verification request comprises at least an indication of a mobile driver's license (mDL) associated with a third user and an indication of the delegated action;
determining, by a user authentication circuitry and based on the indication of the mDL, an authority verification result identifying whether the third user is authorized to perform the delegated action; and
causing, by the communications hardware and based on the authority verification result, transmission of an indication of the authority verification result to the second user device.

2. The method of claim 1, further comprising:
receiving, by the communications hardware, an authentication request from the first user device, wherein the authentication request comprises authentication data associated with at least the first user or the first user device;
determining, by the user authentication circuitry and based on the authentication request, a successful authentication result; and
establishing, by the user authentication circuitry, an authenticated session with the first user, wherein the authority delegation request is received during the authenticated session.

3. The method of claim 1, further comprising:
generating, by mDL management circuitry and based on the indication of the mDL, a digital token comprising cryptographic information associated with the mDL;
transmitting, by the communications hardware, the digital token to an issuing authority (IA) system associated with an IA that provisioned the mDL; and
receiving, by the communications hardware and from the IA system, a mDL validity response, wherein the mDL validity response indicates credential data associated with the mDL.

4. The method of claim 3, wherein the indication of the mDL comprises one or more of cryptographical information associated with the mDL, cryptographical information associated with a user device to which the mDL corresponds, desired credential data associated with the mDL, location data, user profile data, user account data, social media data, or smart wallet identification data.

5. The method of claim 3, further comprises:
determining, by the user authentication circuitry, a metadata parameter set based on the authority verification request;
determining, by the user authentication circuitry and using an authentication scoring model, an authentication score, wherein the authentication score is based on the mDL validity response and the metadata parameter set;
comparing, by the user authentication circuitry, the authentication score to an authentication threshold; and
determining, by the user authentication circuitry and based on the comparing, the authority verification result.

6. The method of claim 5, further comprising:
in response to an unsuccessful authority verification result:
transmitting, by the communications hardware, a supplemental verification request to the second user device;
receiving, by the communications hardware, a completed supplemental verification request from the second user device; and
determining, by the user authentication circuitry and based on the completed supplemental verification request, an updated authority verification result.

7. The method of claim 1, further comprising:
in an instance in which the authority verification request does not comprise the indication of the mDL:
determining, by the user authentication circuitry, the authority verification result based on a standard method of verification.

8. The method of claim 1, further comprising:
in response to a successful authority verification result, transmitting, by the communications hardware, a completed action notification to the first user device.

9. An apparatus for verifying a delegate, the apparatus comprising:
communications hardware configured to receive an authority delegation request from a first user device associated with a first user, wherein the authority delegation request comprises a delegation parameter set;
user delegation circuitry configured to:
determine, based on the delegation parameter set, a delegated action, and
store the delegated action in a user authority delegation profile associated with the first user;
the communications hardware further configured to receive an authority verification request from a second user device associated with a second user, wherein the authority verification request comprises at least an indication of a mobile driver's license (mDL) associated with a third user and an indication of the delegated action;
user authentication circuitry configured to determine, based on the indication of the mDL, an authority verification result identifying whether the third user is authorized to perform the delegated action; and
communications circuitry further configured to cause, based on the authority verification result, transmission of an indication of the authority verification result to the second user device.

10. The apparatus of claim 9, wherein the communications hardware is further configured to:
receive an authentication request from the first user device, wherein the authentication request comprises authentication data associated with at least the first user or the first user device; and
the user authentication circuitry further configured to:
determine, based on the authentication request, a successful authentication result; and
establishing an authenticated session with the first user, wherein the authority delegation request is received during the authenticated session.

11. The apparatus of claim 9, further comprising mDL management circuitry, wherein the mDL management circuitry is configured to:
generate, based on the indication of the mDL, a digital token comprising cryptographic information associated with the mDL; and
the communications hardware further configured to:
transmit the digital token to an issuing authority (IA) system associated with an IA that provisioned the mDL; and
receive, from the IA system, a mDL validity response, wherein the mDL validity response indicates credential data associated with the mDL.

12. The apparatus of claim 11, wherein the indication of the mDL comprises one or more of cryptographical information associated with the mDL, cryptographical information associated with a user device to which the mDL corresponds, desired credential data associated with the mDL, location data, user profile data, user account data, social media data, or smart wallet identification data.

13. The apparatus of claim 11, wherein the user authentication circuitry is further configured to:
determine a metadata parameter set based on the authority verification request;
determine, using an authentication scoring model, an authentication score, wherein the authentication score is based on the mDL validity response and the metadata parameter set;
compare the authentication score to an authentication threshold; and
determine, based on the comparing, the authority verification result.

14. The apparatus of claim 13, wherein the communications hardware is further configured to:
in response to an unsuccessful authority verification result:
transmit a supplemental verification request,
receive a completed supplemental verification request from the second user device; and
the user authentication circuitry further configured to determine, based on the completed supplemental verification request, an updated authority verification result.

15. The apparatus of claim 9, wherein the user authentication circuitry is further configured to:
in an instance in which the authority verification request does not comprise the indication of the mDL:
determine the authority verification result based on a standard method of verification.

16. The apparatus of claim 9, wherein the communications hardware is further configured to transmit a completed action notification to the first user device.

17. A computer program product for verifying a delegate, the computer program product comprising a non-transitory computer-readable storage medium storing instructions that, when executed by an apparatus, cause the apparatus to:
receive an authority delegation request from a first user device associated with a first user, wherein the authority delegation request comprises a delegation parameter set;
determine, based on the delegation parameter set, a delegated action;
store the delegated action in a user authority delegation profile associated with the first user;
receive an authority verification request from a second user device associated with a second user, wherein the authority verification request comprises at least an indication of a mobile driver's license (mDL) associated with a third user and an indication of the delegated action;
determine, based on the indication of the mDL, an authority verification result identifying whether the third user is authorized to perform the delegated action; and
cause, based on the authority verification result, transmission of an indication of the authority verification result to the second user device, wherein the indication is indicative of whether the third user is authorized to perform the delegated action.

18. The computer program product of claim 17, wherein the instructions, when executed by the apparatus, further cause the apparatus to:
generate, based on the indication of the mDL, a digital token comprising cryptographic information associated with the mDL;
transmit the digital token to an issuing authority (IA) system associated with an IA that provisioned the mDL; and
receive, from the IA system, a mDL validity response, wherein the mDL validity response indicates credential data associated with the mDL.

19. The computer program product of claim 18, wherein the instructions, when executed by the apparatus, further cause the apparatus to:
determine a metadata parameter set based on the authority verification request;
determine, using an authentication scoring model, an authentication score, wherein the authentication score is based on the mDL validity response and the metadata parameter set;
compare the authentication score to an authentication threshold; and
determine, based on the comparing, the authority verification result.

20. The computer program product of claim 19, wherein the instructions, when executed by the apparatus, further cause the apparatus to:
in response to an unsuccessful authority verification result:
transmit a supplemental verification request to the second user device;
receive a completed supplemental verification request from the second user device; and
determine, based on the completed supplemental verification request, an updated authority verification result.
